(19) United States
(12) Patent Application Publication
(10) Pub. No.: US 2017/0019956 A1
(43) Pub. Date: Jan. 19, 2017

(54) INDUCTION HEATING SYSTEMS, SUPPORTS, AND METHODS

(71) Applicant: The Boeing Company, Huntington Beach, CA (US)

(72) Inventors: Cameron K. Chen, Seattle, WA (US); Marc R. Matsen, Seattle, WA (US)

(73) Assignee: The Boeing Company, Huntington Beach, CA (US)

(21) Appl. No.: 14/801,295

(22) Filed: Jul. 16, 2015

(51) Int. Cl. H05B 6/10; H05B 6/02; H05B 6/36

(52) U.S. Cl. CPC H05B 6/10; H05B 6/36; H05B 6/02

(57) ABSTRACT

The disclosed induction heating systems include an induction heating-resistant support beam, one or more legs, and an induction coil. The support beam includes a plurality of metal sheets and a plurality of electrically insulating layers interspersed among the metal sheets. Each metal sheet has a thickness that is sized to substantially cancel eddy currents induced in the metal sheet by an alternating magnetic field that may be generated by the induction coil. The support beam and leg(s) are configured to support a workpiece in an induction heating volume defined by the induction coil. The induction coil is configured to generate the alternating magnetic field within the induction heating volume sufficient to heat the workpiece. Methods of induction heating include placing a workpiece, such as a die, within an induction heating volume, supporting the workpiece within the induction heating volume with an induction-heating resistant support beam, and inductively heating the workpiece.

### FIELD

The present disclosure relates to induction heating systems, supports, and methods.

### BACKGROUND

Press forming, also called die pressing, is a method of forming parts that involves the application of pressure or force to a workpiece (typically a metal workpiece) as it is held within a die. To reduce cracking and other structural anomalies in the workpiece during the formation process, the workpiece may be heated, directly or by contact with a heated die. Sufficient heating may include heating the workpiece to greater than about 120° C. (about 250° F.) or greater than about 150° C. (about 300° F.).

Smaller workpieces and dies may be heated in a conventional oven or with alternative methods such as induction heating. For larger objects, heating in a conventional oven may become impractical or uneconomical because of the size of the oven required, the energy required to maintain the oven temperature, or the time to heat the object. For example, heating a steel die that is about 100 kg (220 pounds) and 0.8 m (2.5 feet) long to a temperature of about 165° C. (330° F.) may require 2-2.5 hours in a conventional oven. Larger objects may require longer times.

Induction heating is a technique to heat an electrically conductive object (referred to as the heating workpiece of the induction heating system) that may be quick and efficient. The heating workpiece is located in an induction heating volume where an alternating magnetic field is generated by an induction coil. The magnetic field causes eddy currents to circulate on the heating workpiece in loops perpendicular to the direction of the magnetic field. These eddy currents cause resistive heating (also called Joule heating) in the heating workpiece due to the electrical resistance of the heating workpiece. The eddy currents and consequent heat generation are confined generally to a thin surface region of the heating workpiece characterized by the frequency-dependent skin depth parameter. The skin depth (also called the electrical skin depth and the electromagnetic skin depth) is proportional to the inverse square root of the frequency of the alternating magnetic field. The efficiency of induction heating is related to the intensity and frequency of the alternating magnetic field, the geometry of the induction coil, the relative size of the induction coil and the heating workpiece, and the material of the heating workpiece.

Because the heat is generated in the workpiece, the components of an induction heating system are not necessarily hot or heated. However, metal structures within the induction heating volume may be heated along with the heating workpiece. Hence, metal structures within the induction heating volume are avoided.

For small objects, supporting the object within the induction heating volume requires few compromises. Non-conductive structures of plastic, composite, ceramic, cement, or wood may support the small object from inside or outside of the induction heating volume. The induction coil may be formed as a solenoid, with a relatively large and uniform magnetic field within the cylindrical central volume of the solenoid. The induction coil and the heating workpiece may be small enough to move without cumbersome special precautions.

For large objects, supporting the object in an induction heating system becomes challenging.

One approach to inductively heating large objects is to design the induction coil with a relatively open induction heating volume, e.g., a flat induction coil or a C-profile induction coil. Such induction coils create weaker and/or less uniform magnetic fields than a solenoid design (which encloses the heating workpiece in two directions). Another approach to inductively heating large objects is to use a large metal support beam (or rails) to support the large object in the induction heating volume. The support beam is metal to provide the necessary stiffness and strength to support the large object. However, because the support is metal, it heats in the induction heating volume and, therefore, is cooled during heating (e.g., with a water circulation system) and/or after heating (e.g., by waiting for the support to cool to ambient temperature). Yet another approach to inductively heating large objects is to move the large (and hot) object and/or induction coil vertically. Such an approach may be impractical due to safety and size concerns of lifting a large, heavy, and possibly hot object.

Hence, improved systems and methods for induction heating of large objects are desired.

### SUMMARY

Induction heating systems, supports, and methods are disclosed. Induction heating systems include a support beam, one or more legs, and an induction coil. The support beam is an induction heating-resistant support beam that includes a plurality of metal sheets and a plurality of electrically insulating layers interspersed among the metal sheets. The electrically insulating layers electrically isolate the metal sheets from one another. Each metal sheet of the plurality of metal sheets has a thickness that is sized to substantially cancel eddy currents induced in the metal sheet by an alternating magnetic field that may be generated by the induction coil. The leg(s) are configured to support the support beam with a workpiece resting on at least a portion of a span of the support beam. The leg(s) are spaced apart from the span. The support beam is configured to support the workpiece resting on the portion of the span. The induction coil defines an induction heating volume and the span is at least partially within the induction heating volume. The induction coil is configured to generate the alternating magnetic field within the induction heating volume sufficient to heat the workpiece. The generated alternating magnetic field is substantially perpendicular to the thicknesses of the metal sheets of the plurality of metal sheets of the support beam (i.e., the generated alternating magnetic field is substantially parallel to the local planes of the metal sheets). The span may be elongated and horizontal. The metal sheets may be aligned substantially perpendicularly to the elongated direction of the span. The alternating magnetic field may have a frequency of at least 10 Hz and at most 100 kHz.

Methods of induction heating include placing a workpiece, such as a die, within an induction heating volume of an induction coil, supporting the workpiece within the induction heating volume with a support assembly, and inductively heating the workpiece by applying to the induction coil an alternating current. The support assembly used in the methods includes a support beam and one or more legs. The support beam includes a plurality of metal sheets and a plurality of electrically insulating layers interspersed among the metal sheets. The electrically insulating layers electrically isolate the metal sheets from one another. Each metal sheet of the plurality of metal sheets has a thickness sized to substantially cancel eddy currents induced in the metal sheet by an alternating magnetic field substantially perpendicular to the thickness. The alternating magnetic field is generated by the alternating current in the induction coil.

### BRIEF DESCRIPTION OF THE DRAWINGS

FIG. 1 is a diagrammatic representation of an example of an induction heating system of the present disclosure.

FIG. 2 is a cross sectional view along the section line 2-2 of FIG. 1, detailing the internal structure of a support beam of the induction heating system of FIG. 1.

FIG. 3 is a cross sectional view along the section line 2-2 of FIG. 1, illustrating an alternate example of the internal structure of the support beam.

FIG. 4 is a cross sectional view along the section line 2-2 of FIG. 1, illustrating another alternate example of the internal structure of the support beam.

FIG. 5 is a diagrammatic representation of methods according to the present disclosure.

### DESCRIPTION

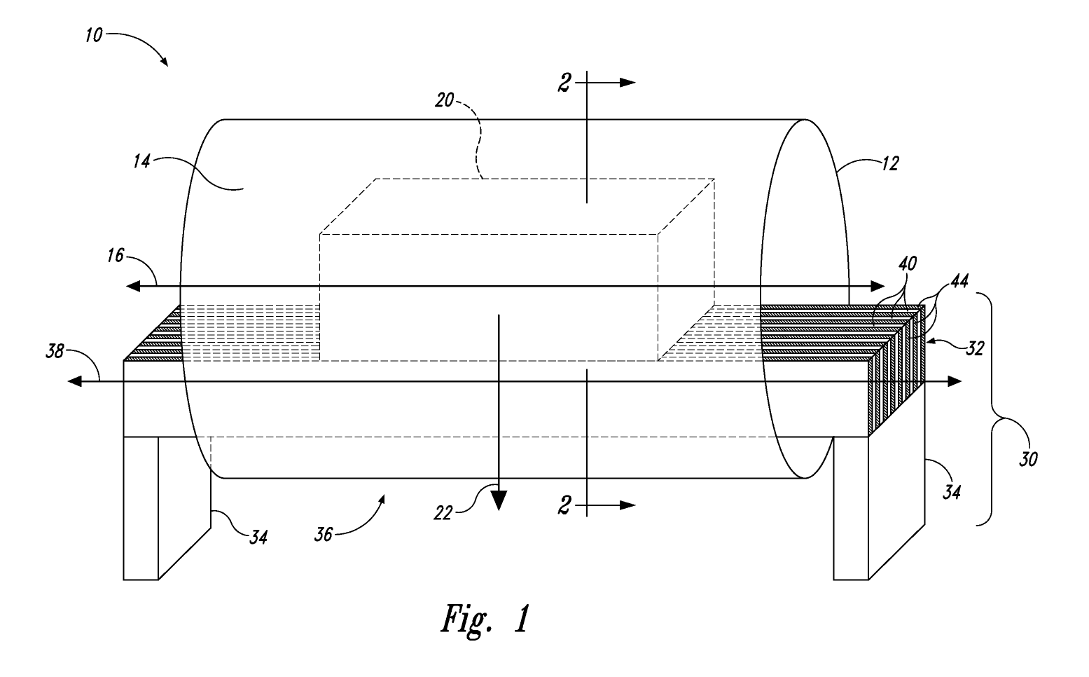

FIGS. 1-5 illustrate induction heating systems 10 and associated methods 100. In general, in the drawings, elements that are likely to be included in a given embodiment are illustrated in solid lines, while elements that are optional or alternatives are illustrated in dashed lines. However, elements that are illustrated in solid lines are not essential to all embodiments of the present disclosure, and an element shown in solid lines may be omitted from a particular embodiment without departing from the scope of the present disclosure. Elements that serve a similar, or at least substantially similar, purpose are labeled with numbers consistent among the figures. Like numbers in each of the figures, and the corresponding elements, may not be discussed in detail herein with reference to each of the figures. Similarly, all elements may not be labeled or shown in each of the figures, but reference numerals associated therewith may be used for consistency. Elements, components, and/or features that are discussed with reference to one or more of the figures may be included in and/or used with any of the figures without departing from the scope of the present disclosure.

As shown in the example of FIG. 1, an induction heating system 10 includes an induction coil 12 (also referred to as an induction heating element) and a support assembly 30. The induction heating system 10 is configured to heat a workpiece 20 by inductive heating within an induction heating volume 14 defined by the induction coil 12. The induction coil 12 is configured to generate an alternating magnetic field (also referred to as the magnetic component of an electromagnetic field) within the induction heating volume 14 sufficient to heat the workpiece 20.

The support assembly 30 (also referred to as an induction heating-resistant support assembly) includes a support beam 32 (also referred to as an induction heating-resistant support beam) and at least one leg 34 (e.g., one, two, or more legs 34). The support beam 32 is configured (a) to support the workpiece 20 resting on at least a portion of a span 36 of the support beam 32 and (b) to resist induction heating when subject to the alternating magnetic field of the induction heating system 10. In the induction heating system 10, the span 36 of the support assembly 30 is at least partially within the induction heating volume 14. Hence, the span 36 is a section of the support beam 32 within the induction heating volume 14. Because the support beam 32 has a low susceptibility to the alternating magnetic field generated by the induction coil 12, the support beam 32 does not need to be actively cooled (e.g., by a water circulation system and/or fans) while the workpiece 20 is heated on the support beam 32. Thus, the support assembly 30 and the associated induction heating system 10 may be less complex than a conventional support assembly or induction heating system (which does not incorporate the support beam 32).

The workpiece 20 is electrically conductive and/or includes electrically conductive components suitable for induction heating. Further, the workpiece 20 may be magnetic (e.g., ferromagnetic or ferrimagnetic). Magnetic materials may be heated more efficiently by induction heating than non-magnetic materials. The workpiece 20 may include, may be composed substantially of, or may be composed essentially of, metal, iron, steel, magnetic material, ferromagnetic material, and/or ferrimagnetic material.

The workpiece 20 generally is a large workpiece, which has a large size and/or which is heavy. The workpiece 20 may have a largest dimension (e.g., a length or an elongated dimension) that is at least 20 cm (centimeters), at least 50 cm, at least 100 cm, or at least 200 cm. The workpiece 20 may have a mass that is greater than 10 kg, greater than 20 kg, greater than 40 kg, or greater than 80 kg. The workpiece 20 may have a lineal mass density (along an elongated dimension) of greater than 10 kilograms per lineal meter, greater than 20 kilograms per lineal meter, greater than 50 kilograms per lineal meter, or greater than 100 kilograms per lineal meter. The lineal mass density of the workpiece 20 is the mass of the workpiece 20 divided by the length of largest dimension of the workpiece 20.

The workpiece 20 is an object that is desired to be heated (and, hence, may be called a heating workpiece). The workpiece 20 may be a stock piece such as a billet, a rod, a plate, or a sheet. The workpiece 20 may be a tool or other component to form another workpiece (a target workpiece of a forming operation such as die pressing). For example, the workpiece 20 may be a tool, a forming die, or a portion thereof. Forming dies may include two or more die members, e.g., a die base and a punch.

The induction coil 12 is configured to generate and/or to apply an alternating magnetic field (also referred to as an induction field) sufficient to heat the workpiece 20 (e.g., when the workpiece 20 is resting on at least a portion of the span 36 of the support beam 32 within the induction heating volume l4). The induction coil 12 is configured to permit the flow of alternating electrical current through the induction coil 12. The induction coil 12 is arranged such that the flow of alternating electrical current generates the alternating magnetic field within the induction heating volume 14. The induction heating system 10 may include a power supply configured to supply the alternating electrical current to the induction coil 12.

The induction coil 12 is configured to generate and/or to apply the alternating magnetic field with an alternating magnetic field axis 16 within the induction heating volume 14 oriented in a predetermined direction. Hence, the direction of the alternating magnetic field is described by the alternating magnetic field axis 16. The orientation of the alternating magnetic field axis 16 is determined by the shape, configuration, and orientation of the induction coil 12. The alternating magnetic field axis 16 may be at least substantially horizontal, at least substantially vertical, or oriented at another angle. Generally, and as shown in the example of FIG. 1, the alternating magnetic field axis 16 is oriented at least substantially parallel to the support beam 32 and/or the span 36, along the length of the support beam 32 and/or span 36. However, the alternating magnetic field axis 16 may be oriented at least substantially perpendicular to the length of the support beam 32 and/or the span 36 (e.g., the example of FIG. 1 could be altered such that the alternating magnetic field axis 16 and the induction coil 12 are oriented vertically while the support beam 32 and span 36 remain horizontal).

The induction coil 12 may include conductive wire and a structural form (also called a structural support) to support the wire. The wire typically is arranged in loops, spirals, and/or helices. Generally, the induction coil 12 at least partially surrounds and/or encircles the support beam 32. For example, and as illustrated in FIG. 1, the induction coil 12 may be in a solenoid configuration that surrounds the span 36 of the support beam 32. In a solenoid configuration, the induction coil 12 is substantially cylindrical with the wire arranged in a substantially cylindrical helix. Even though not shown in FIG. 1, other configurations may be suitable, e.g., a C-profile cylinder (a slit cylinder) or a planar coil. Solenoid configurations tend to concentrate and/or enhance the central magnetic field relative to other configurations and, thus, may be more efficient at induction heating. The induction heating volume 14 is generally within a cavity or a partially enclosed volume defined by the physical shape of the induction coil 12. For a solenoid configuration, the induction heating volume 14 is the substantially cylindrical space within the induction coil 12.

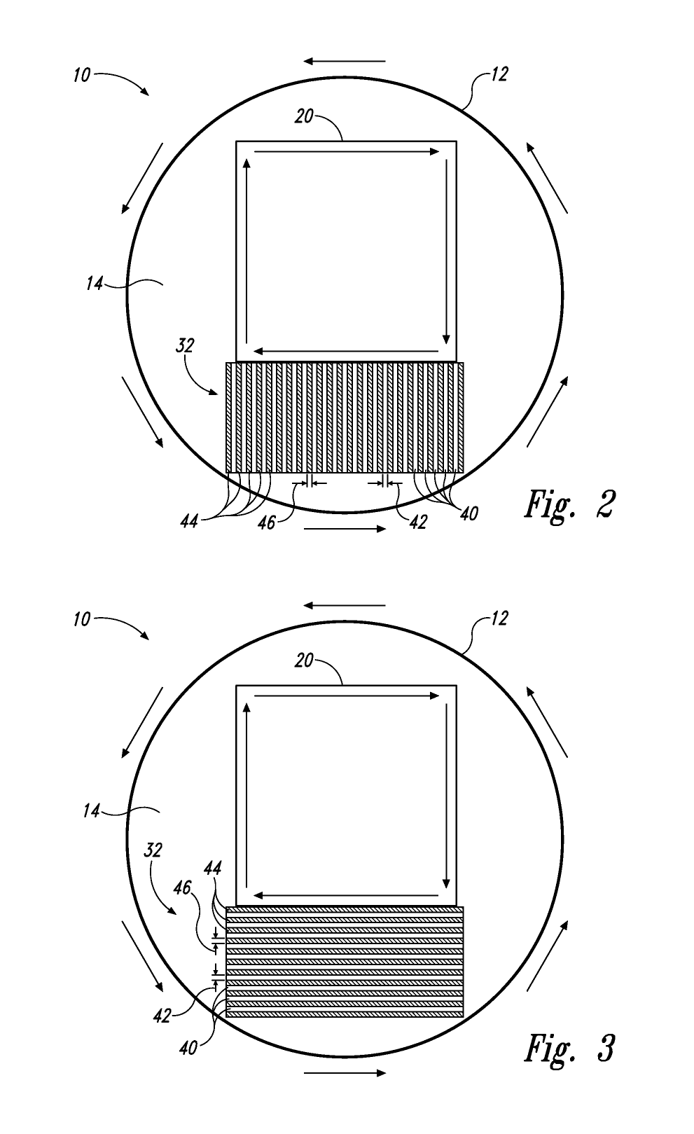

In the induction heating volume 14, the alternating magnetic field of the induction coil 12 causes eddy currents to form in electrically conductive objects. Eddy currents flow in loops perpendicular to the alternating magnetic field axis 16. In the cross section of FIG. 2, the alternating magnetic field axis 16 is perpendicular to the page (and hence not shown in the figure). The arrows around the outer rim of the induction coil 12 indicate a direction of current flow through the induction coil that would generate a magnetic field perpendicular to the page. The arrows within the workpiece 20 represent the eddy currents induced in the workpiece 20 by the alternating magnetic field of the induction coil 12. Eddy currents are confined to a thin surface region of the workpiece 20 characterized by the frequency-dependent skin depth parameter. The skin depth is proportional to the inverse square root of the frequency of the alternating magnetic field. For example, the skin depth of carbon steel (a magnetic steel) is about 0.2 mm (millimeters) at 10 kHz and about 2 mm at 60 Hz. Generally, higher frequencies are more suitable for faster heating and thinner objects, while lower frequencies are more suitable for thicker objects.

The induction coil 12 may be configured to flow an alternating current and/or to generate an alternating magnetic field with a frequency of 50 Hz, 60 Hz, 500 Hz, 1 kHz, 10 kHz, 24 kHz, at least 10 Hz, at least 30 Hz, at least 50 Hz, at least 200 Hz, at least 1 kHz, at most 1 MHz, at most 100 kHz, at most 50 kHz, and/or at most 20 kHz. Though listed as specific values, the list of frequencies and ranges are intended to include frequencies about or approximately the listed value as well as the listed value. Additionally or alternatively, the induction coil 12 may be configured to have a specific value of inductance. The induction heating system 10 (e.g., the induction coil 12 and/or the power supply) may be configured to operate at a desired alternating magnetic field frequency, or frequency range, at one or more of the listed frequencies and/or frequency ranges. For example, the induction heating system 10, or a component thereof, may be configured to operate at a frequency between 50 Hz and 100 kHz.

The induction heating system 10 and/or the induction coil 12 may be configured to inductively heat the workpiece 20 to a surface temperature (and/or an internal temperature) of greater than 100° C., greater than 120° C., greater than 150° C., less than 300° C., less than 250° C., and/or less than 200° C. The induction heating system 10 and/or the induction coil 12 may be configured to inductively heat the workpiece 20 at a rate of greater than 2° C./min (2° C. per minute), greater than 5° C./min, greater than 10° C./min, and/or less than 50° C./min. Further, the induction heating system 10 and/or the induction coil 12 may be configured to inductively heat the support beam 32 at a rate of less than 2° C./min, less than 1° C./min, less than 0.5° C./min, less than 0.2° C/min, or less than 0.1° C/min.

The support assembly 30 is configured to support the workpiece 20 within the induction heating volume 14 and, hence, within the alternating magnetic field when applied by the induction coil 12. The support beam 32 and the leg(s) 34 of the support assembly are configured to hold the weight 22 of the workpiece 20 while the workpiece 20 rests on at least a portion of the span 36 of the support beam 32. The support assembly 30 may be referred to as a table, a bench, or a stand.

The support assembly 30 may be configured to support the workpiece 20 away from the interior walls of the induction coil 12. For example, the support assembly 30 may support the workpiece 20 within the induction heating volume 14 such that the workpiece 20 does not contact (i.e., is spaced away from) the interior walls of the induction coil 12. Additionally or alternatively, the induction heating system 10 may be arranged such that the support assembly 30 does not contact the interior walls of the induction coil 12 and the induction coil 12 does not support the support beam 32. Avoiding contact with the induction coil 12 and avoiding applying the weight 22 of the workpiece 20 and/or the weight of the support assembly 30 to the induction coil 12 may protect the induction coil 12 from wear, damage, and stress. For example, the weight 22 of the workpiece 20 and/or the heat generated by the workpiece 20 could lead to mechanical and/or electrical damage to the induction coil 12. Additionally or alternatively, the mechanical, electrical, and/or safety precaution complexity of the induction heating system 10 may be reduced by configuring the support assembly 30 and/or the induction coil 12 to avoid contact between the induction coil 12 and the workpiece 20 and/or the support assembly 30. Induction coils 12, especially induction coils 12 for large workpieces 20, typically conduct large electrical currents. An electrical or mechanical failure of the induction coil 12 could be hazardous.

The leg(s) 34 are stiff and strong enough to support the support beam 32 with the weight 22 of the workpiece 20. The leg(s) 34 are generally outside of the induction heating volume 14. One or more of the legs 34 may be coupled to the support beam 32, e.g., by fasteners, strapping, bonding, etc., and the support beam 32 may rest on one or more of the legs 34. Typically, the span 36 is supported by the leg(s) 34 near the end(s) of the span 36, without any support leg directly underneath the span 36 or underneath the portion of the span 36 where the workpiece 20 may rest (in which case, the span 36 may be described as an open or clear span). Hence, the center of gravity of the workpiece 20 (as represented by the position of the weight 22 in the example of FIG. 1) may be horizontally offset from the support point(s) of the leg(s) 34.

The support beam 32 is stiff and strong enough to support at least a portion of the workpiece 20 on the span 36. The support beam 32 and/or the span 36 may be configured to be as stiff and strong as a solid metal beam (formed of about the same mass as the support beam 32 and/or the span 36) that may be used to support the workpiece 20 outside of the induction heating volume 14.

The span 36 has a length along a longitudinal direction 38 of the span 36. The span 36 may be elongated, in which case the longitudinal direction 38 may be referred to as the elongated direction. The support beam 32 and the span 36 are configured to support the workpiece 20 generally on and above the span 36. Hence, the span 36 generally is arranged such that the longitudinal direction 38 is at least substantially horizontal. The span 36 generally is sized to hold the workpiece 20 and may have a length and width similar to or larger than the respective length and width of the workpiece 20. The length of the workpiece 20 is generally aligned with the length of the span 36. The length of the span 36 generally is oriented into and/or through the induction heating volume 14. In use, the longitudinal direction 38 is substantially aligned with the alternating magnetic field axis 16. Hence, the span 36 may be as long as or longer than the induction heating volume 14 and/or the induction coil 12. The length of the span 36 may be at least 20 cm, at least 50 cm, at least 100 cm, or at least 200 cm.

With respect to the support beam 32 and/or the span 36, the three Cartesian directions corresponding to the length, width, and depth of the respective body are referred to as longitudinal (lengthwise), lateral (widthwise), and transverse (depthwise), respectively. The longitudinal and lateral directions are illustrated as horizontal in FIGS. 1-4. The transverse direction is illustrated as vertical in FIGS. 1-4.

The workpiece 20 may be at least partially directly supported on the span 36 and/or the workpiece 20 may be at least partially supported by one or more intermediate support structures, such as rollers, sleeves, and/or sheets, between the workpiece 20 and the span 36. The rollers, sleeves, and/or sheets may facilitate transfer of the workpiece 20 to/from the induction heating volume 14. The span 36 and/or the support beam 32 may be configured for contact with the workpiece 20, and/or any intermediate support structures such as rollers, sleeves, and/or sheets, before, during, and after the workpiece 20 is heated. The span 36 and/or the support beam 32 may be resistant to abrasion, wear, and/or high temperatures. Further, the span 36 and/or the support beam 32 may be electrically isolated from the workpiece 20, e.g., by an electrically insulating surface layer on the span 36 and/or by non-conductive intermediate support structures. The span 36 and/or the support beam 32 may be configured to withstand a temperature of greater than 100° C., greater than 120° C., greater than 150° C., less than 300° C., less than 250° C., and/or less than 200° C. The span 36 and/or the support beam 32 may be configured to withstand contact with the workpiece 20 when the workpiece 20 has a surface temperature of greater than 100° C., greater than 120° C., greater than 150° C., less than 300° C., less than 250° C., and/or less than 200° C.

The support beam 32 includes a plurality of metal sheets 40 and a plurality of electrically insulating layers 44 interspersed among the metal sheets 40. The electrically insulating layers 44 are arranged and/or configured to electrically isolate the metal sheets 40 from one another. Generally, the plurality of metal sheets 40 and the plurality of electrically insulating layers 44 are layered and/or stacked together, e.g., alternately layered and/or stacked together, as seen in the cross section of FIG. 2. The example of FIGS. 1-2 illustrates an alternating arrangement of the metal sheets 40 and the electrically insulating layers 44 in which each adjacent pair of metal sheets 40 are separated by one electrically insulating layer 44. However, other arrangements with different numbers and/or types of electrically insulating layers 44 between the metal sheets 40 also may be suitable. As examples, adjacent metal sheets 40 may be separated from one another by at least one (e.g., one, two, or more) electrically insulating layer 44 and the number and/or type of electrically insulating layer(s) 44 between each adjacent pair of metal sheets 40 may be independently selected (e.g., the same or different). The plurality of metal sheets 40 and the plurality of electrically insulating layers 44 may be laminated, bonded, affixed, fastened, or otherwise coupled together to form a unitary support beam 32. For example, the electrically insulating layers 44 may be used to laminate the plurality of metal sheets 40 together.

The metal sheets 40 are in the form of sheets and may be described as generally planar, i.e., each metal sheet 40 is generally broad with a thickness much less than the overall breadth (length and width). The metal sheets 40 each have a thickness 42 (as shown in FIG. 2) sized to at least substantially cancel and/or limit eddy currents induced in the metal sheet 40 by an alternating magnetic field with field lines perpendicular and/or substantially perpendicular to the individual thicknesses 42. Though each metal sheet 40 independently may deviate from a flat plane, the thickness 42 of each metal sheet 40 is perpendicular to the local plane of the length and width of the respective metal sheet 40. Hence, where the thickness 42 is described perpendicular to a reference direction, one may describe the local plane of the respective metal sheet 40 as parallel to the reference direction. For example, each thickness 42 is sized to at least substantially cancel and/or limit eddy currents induced in the respective metal sheet 40 by an alternating magnetic field with field lines parallel and/or substantially parallel to the local plane of the respective metal sheet 40.

The thickness 42 of each metal sheet 40 may be independently selected (i.e., at least one metal sheet 40 may have a thickness 42 that is different than at least one other metal sheet 40). In the induction heating system 10, the thicknesses 42 of the metal sheets 40 are arranged at least substantially perpendicular to the alternating magnetic field axis 16 (i.e., the alternating magnetic field axis 16 is at least substantially parallel to the corresponding local planes of the metal sheets 40). Thus, in use, the thicknesses 42 are at least substantially perpendicular to the alternating magnetic field generated by the induction coil 12 (and the alternating magnetic field is at least substantially parallel to the corresponding local planes of the metal sheets 40).

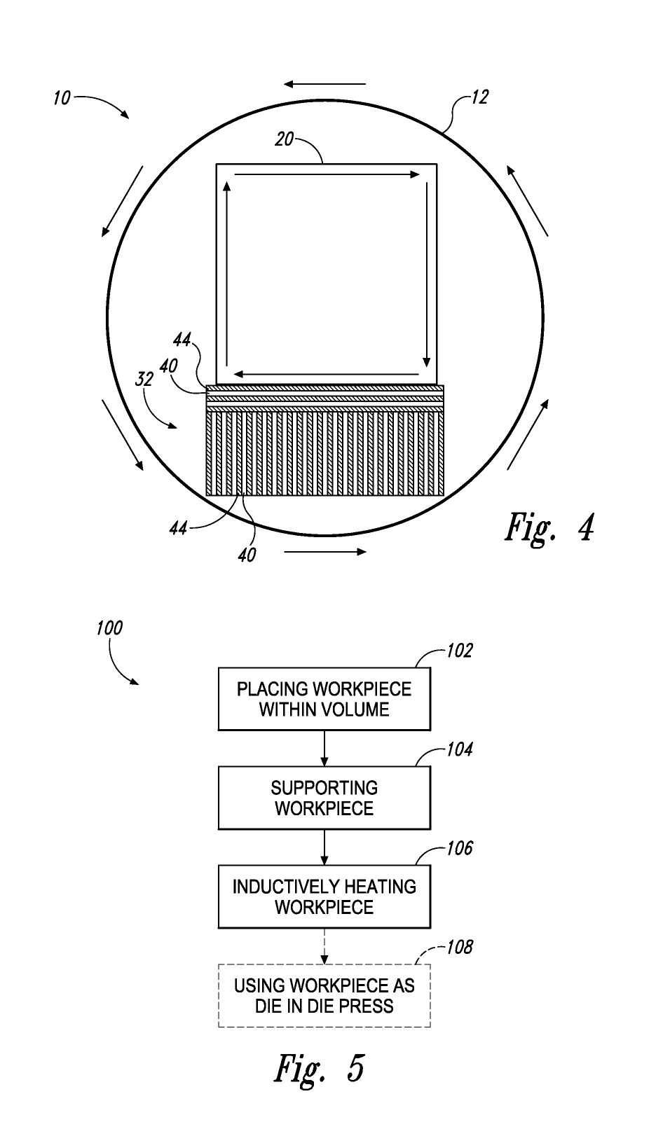

FIGS. 1-2 illustrate the example where the thicknesses 42 of the metal sheets 40 are oriented laterally (the metal sheets being in a lateral stack), substantially horizontal, and perpendicular to the alternating magnetic field axis 16 and the longitudinal direction 38 of the span 36. Additionally or alternatively, and as illustrated in the examples of FIGS. 3-4, at least some of the metal sheets 40 may be oriented with their thicknesses 42 non-lateral, e.g., in the transverse direction (vertical), substantially in the transverse direction, and/or inclined between the lateral and the transverse directions (i.e., the thicknesses 42 are oriented in a direction in the lateral-transverse plane which is non-lateral and non-transverse). Thus, the support beam 32 may include metal sheets 40 oriented in a lateral stack, a transverse stack, a vertical stack, and/or a stack inclined between the lateral and the transverse directions (also referred to as an inclined stack or a tilted stack). As illustrated in FIG. 4, the support beam 32 may include more than one stack of metal sheets 40. Where support beam 32 includes more than one stack of metal sheets 40, the stacks of the metal sheets 40 may be oriented differently and the metal sheets 40 and/or the corresponding electrically insulating layers 44 may have different thicknesses and/or compositions.

If a metal structure is thin enough (perpendicular to the magnetic field lines, e.g., the local magnetic field axis), induced eddy currents on opposite faces of the structure may significantly, or essentially completely, cancel, resulting in little to no eddy currents on the surfaces of the metal structure. With little to no eddy current, the metal structure experiences little to no consequent Joule heating. The thickness at which eddy currents are affected is related to the skin depth of the metal structure. The thickness 42 of each metal sheet 40 may be at most two times (e.g., less than two times, about equal to, or less than) the skin depth of the metal sheet at one or more magnetic field frequencies of the induction heating system 10. Suitable thicknesses may be less than 5 mm, less than 3 mm, less than 2 mm, less than 1 mm, greater than 0.1 mm, and/or greater than 0.5 mm. For example, at a magnetic field frequency of 10 kHz, the skin depth of 300-series stainless steel (a non-magnetic steel) is about 4 mm and the skin depth of aluminium is about 0.9 mm.

The metal sheets 40 may all be composed of the same material or at least one of the metal sheets 40 may be composed of a different material than at least one other metal sheet 40. Each metal sheet 40 independently may be non-magnetic, paramagnetic, diamagnetic, and/or magnetic (e.g., ferromagnetic or ferrimagnetic). Generally, non-magnetic, paramagnetic, and diamagnetic materials are less efficiently heated by induction than magnetic materials. Each metal sheet 40 independently may be composed essentially of one or more metals selected from the group consisting of aluminium, aluminium alloy, steel, non-magnetic steel, stainless steel, non-magnetic stainless steel, 300-series stainless steel, nickel alloy, chromium alloy, and INCONEL-brand nickel-chromium alloy.

The electrically insulating layers 44 of the support beam 32 are non-conductive and, hence, substantially unresponsive to an alternating magnetic field. The electrically insulating layers 44 may all be composed of the same material or at least one of the electrically insulating layers 44 may be composed of a different material than at least one other electrically insulating layer. Each electrically insulating layer 44 independently may be composed essentially of one or more materials selected from the group consisting of a polymer, a fiber-reinforced composite (e.g., fiberglass), a particulate-reinforced composite, an epoxy, a polyurethane, an acrylonitrile butadiene styrene polymer, polyether ether ketone (PEEK), a fluoropolymer, and polytetrafluoroethylene (PTFE). Where the electrically insulating layer 44 includes fiber and/or particulate, the fibers and/or the particulate generally are electrically insulating, for example, composed essentially of glass, polymer, and mineral materials.

The metal sheets 40 of the support beam 32 may provide most (e.g., substantially all) of the load bearing strength of the support beam 32. The electrically insulating layers 44 may be structurally weaker than the metal sheets 40, especially when the support beam 32 experiences elevated temperatures such as when in contact with the workpiece 20 during and/or after heating. The electrically insulating layers 44 may contribute relatively little to the load bearing capacity of the support beam. The primary contribution of the electrically insulating layers 44 to the load bearing capacity of the support beam may be due to the cross support between the metal sheets 40, limiting the relative motion of metal sheets 40 and/or buckling of the individual metal sheets 40.

The number and sizes of metal sheets 40 in a support beam 32 is determined largely by the workpiece 20 to be supported and the overall length and/or width of the span 36 and/or the support beam 32 (more higher-strength metal sheets 40 and larger metal sheets 40 may support more weight). For example, the overall depth and/or width of the support beam 32 may be at least 10 cm, at least 20 cm, at least 50 cm, at most 100 cm, and/or at most 200 cm. The number of metal sheets 40 in the support beam 32 and/or the number of metal sheets 40 in a stack in the support beam 32 may be at least 10, at least 20, or at least 50.

The number and sizes of the electrically insulating layers 44 are determined largely by the workpiece 20 to be supported (fewer lower-strength electrically-insulating layers 44 may support more weight) and the electromagnetic effects created by placing the metal sheets 40 in proximity to one another (e.g., side by side). A larger spacing between adjacent metal sheets 40 isolates the metal sheets 40 better and reduces electromagnetic effects between the metal sheets 40. For example, adjacent metal sheets 40 may be spaced apart by, and each electrically insulating layer 44 independently may have a thickness 46 of, less than 20 mm, less than 10 mm, less than 5 mm, less than 3 mm, less than 2 mm, less than 1 mm, greater than 0.1 mm, greater than 0.5 mm, greater than 2 mm, and/or greater than 5 mm. The number of electrically insulating layers 44 in the support beam 32 and/or the number of electrically insulating layers 44 in a stack in the support beam 32 may be at least 10, at least 20, or at least 50.

FIG. 5 represents methods 100 of induction heating. Methods 100 generally include using the induction heating system 10 and/or the support assembly 30 but are not necessarily limited to the specific systems and assemblies disclosed. Methods 100 include placing 102 a workpiece (e.g., workpiece 20) , which may also be called a heating workpiece, within an induction heating volume (e.g., induction heating volume 14) of an induction coil (e.g., induction coil 12), supporting 104 the workpiece within the induction heating volume with an induction heating-resistant support assembly (e.g., support assembly 30) that includes an induction heating-resistant support beam (e.g., support beam 32), and inductively heating 106 the workpiece by applying alternating current to the induction coil. Methods 100 may include removing the workpiece from the induction heating volume after the inductively heating 106.

The inductively heating 106 may include heating the workpiece to a desired and/or predetermined temperature, such as greater than 100° C., greater than 120° C., greater than 150° C., less than 300° C., less than 250° C., and/or less than 200° C. The inductively heating 106 may include heating the workpiece more than the induction heating-resistant support beam. The inductively heating 106 may include heating the workpiece at a rate of greater than 2° C./min, greater than 5° C./min, greater than 10° C./min, and/or less than 50° C./min. The inductively heating 106 may include heating the induction heating-resistant support beam at a rate of less than 2° C./min, less than 1° C./min, less than 0.5° C./min, less than 0.2° C./min, or less than 0.1° C./min.

The inductively heating 106 may include applying an alternating current to the induction coil. The applying the alternating current to the induction coil may include applying a sufficient magnitude and/or frequency of current to generate the desired alternating magnetic field in the induction heating volume. The alternating current may have the same frequency as the desired alternating magnetic field. The desired alternating magnetic field may be the alternating magnetic field described with respect to the systems and assemblies.

The efficiency of heating, the rate of heating, and the preference for heating one object (e.g., the workpiece) over another (e.g., the support beam) may be controlled by selecting the alternating current magnitude and/or frequency and/or by controlling the magnitude, direction, and/or frequency of the alternating magnetic field. Additionally or alternatively, the efficiency, rate, and/or preference may be controlled by positioning the workpiece within the induction coil and/or the induction heating volume.

Methods 100 may include methods of forming a target workpiece with an induction-heated die. In such methods, the workpiece of the induction heating (the object heated by inductively heating 106) is a die. Thus, placing 102 is placing a die within an induction heating volume of an induction coil, supporting 104 is supporting the die within the induction heating volume, and inductively heating 106 is inductively heating the die to form a heated die. Further, methods 100 may include using 108 the die in a die press to form a target workpiece, for example, removing the heated die from the induction heating volume, placing the heated die in a die press, placing a target workpiece into the die press, and/or forming the target workpiece into a final form with the heated die in the die press. Using 108 may include heating two or more die members of the die simultaneously within the induction heating volume. The target workpiece may be composed essentially of metal, aluminium, and/or aluminium alloy. The final form of the target workpiece may be an aerospace component such as an aircraft stringer or frame component.

Examples of inventive subject matter according to the present disclosure are described in the following enumerated paragraphs.

A1. An induction heating-resistant support assembly comprising:

a support beam including a plurality of metal sheets and a plurality of electrically insulating layers interspersed among the metal sheets, electrically isolating the metal sheets from one another, wherein each metal sheet of the plurality of metal sheets has a thickness sized to substantially cancel, cancel, substantially limit, and/or limit eddy currents induced in the metal sheet by an alternating magnetic field substantially perpendicular or perpendicular to the thickness; and

one or more legs, optionally two or more legs, configured to support the support beam with a workpiece resting on at least a portion of a span of the support beam, optionally wherein the portion is the span, wherein the one or more legs are spaced apart from the span, and wherein the support beam is configured to support the workpiece resting on the portion of the span.

A2. The support assembly of paragraph A1, wherein each metal sheet of the plurality of metal sheets is electrically isolated from the remaining metal sheets of the plurality of metal sheets by at least one electrically insulating layer of the plurality of electrically insulating layers.

A3. The support assembly of any of paragraphs A1-A2, wherein the plurality of metal sheets and the plurality of electrically insulating layers are layered and/or stacked together, and optionally alternately layered and/or stacked together.

A4. The support assembly of any of paragraphs A1-A3, wherein the plurality of metal sheets are laminated together, optionally by and/or with the plurality of electrically insulating layers.

A5. The support assembly of any of paragraphs A1-A4, wherein each metal sheet of the plurality of metal sheets is composed of an identical material.

A6. The support assembly of any of paragraphs A1-A5, wherein each metal sheet of the plurality of metal sheets is non-magnetic, paramagnetic, or diamagnetic.

A7. The support assembly of any of paragraphs A1-A6, wherein each metal sheet of the plurality of metal sheets independently is composed essentially of one or more metals selected from the group consisting of aluminium, aluminium alloy, steel, non-magnetic steel, stainless steel, non-magnetic stainless steel, 300-series stainless steel, nickel alloy, chromium alloy, and INCONEL-brand nickel-chromium alloy.

A8. The support assembly of any of paragraphs A1-A7, wherein each layer of the plurality of electrically insulating layers is composed of an identical material.

A9. The support assembly of any of paragraphs A1-A8, wherein each layer of the plurality of electrically insulating layers independently is composed essentially of one or more materials selected from the group consisting of a polymer, a fiber-reinforced composite, fiberglass, a particulate-reinforced composite, an epoxy, a polyurethane, an acrylonitrile butadiene styrene polymer, polyether ether ketone, a fluoropolymer, and polytetrafluoroethylene.

A9.1. The support assembly of paragraph A9, wherein the fiber-reinforced composite includes at least one of glass fibers, polymer fibers, and mineral fibers.

A9.2. The support assembly of any of paragraphs A9-A9.1, wherein the particulate-reinforced composite includes at least one of glass particulate, polymer particulate, and mineral particulate.

A10. The support assembly of any of paragraphs A1-A9.2, wherein the alternating magnetic field has a frequency of 50 Hz, 60 Hz, 500 Hz, 1 kHz, 10 kHz, 24 kHz, at least 10 Hz, at least 30 Hz, at least 50 Hz, at least 200 Hz, at least 1 kHz, at most 1 MHz, at most 100 kHz, at most 50 kHz, and/or at most 20 kHz, and optionally wherein any of the listed frequencies are about or approximately the listed value.

A11. The support assembly of any of paragraphs A1-A10, wherein the thickness of each metal sheet of the plurality of metal sheets is less than two times, optionally less than, a skin depth of the metal sheet at an alternating magnetic field frequency of 50 Hz, 60 Hz, 500 Hz, 1 kHz, 10 kHz, 24 kHz, at least 10 Hz, at least 30 Hz, at least 50 Hz, at least 200 Hz, at least 1 kHz, at most 1 MHz, at most 100 kHz, at most 50 kHz, and/or at most 20 kHz, and optionally wherein any of the listed frequencies are about or approximately the listed value.

A12. The support assembly of any of paragraphs A1-A11, wherein the thickness of each metal sheet of the plurality of metal sheets is less than 5 mm, less than 3 mm, less than 2 mm, less than 1 mm, greater than 0.1 mm, and/or greater than 0.5 mm.

A13. The support assembly of any of paragraphs A1-A12, wherein adjacent metal sheets of the plurality of metal sheets are spaced apart by one or more electrically insulating layers of the plurality of electrically insulating layers by less than 20 mm, less than 10 mm, less than 5 mm, less than 3 mm, less than 2 mm, less than 1 mm, greater than 0.1 mm, greater than 0.5 mm, greater than 2 mm, and/or greater than 5 mm.

A14. The support assembly of any of paragraphs A1-A13, wherein a thickness of each electrically insulating layer of the plurality of electrically insulating layers is less than 20 mm, less than 10 mm, less than 5 mm, less than 3 mm, less than 2 mm, less than 1 mm, greater than 0.1 mm greater than 0.5 mm, greater than 2 mm, and/or greater than 5 mm.

A15. The support assembly of any of paragraphs A1-A14, wherein the thicknesses of the metal sheets of the plurality of metal sheets are oriented substantially perpendicular, optionally perpendicular, to a longitudinal direction of the span.

A16. The support assembly of any of paragraphs A1-A15, wherein the thickness of at least one, optionally each, metal sheet of the plurality of metal sheets is oriented substantially laterally, optionally laterally.

A17. The support assembly of any of paragraphs A1-A16, wherein the thickness of at least one, optionally each, metal sheet of the plurality of metal sheets is oriented substantially transversely, optionally transversely, to a lateral direction and a longitudinal direction of the span.

A18. The support assembly of any of paragraphs A1-A17, wherein the thickness of at least one, optionally each, metal sheet of the plurality of metal sheets is oriented substantially vertically, optionally vertically.

A19. The support assembly of any of paragraphs A1-A18, wherein the support beam is configured to support the workpiece resting on the portion of the span of the support beam while the support beam is supported by the one or more legs.

A20. The support assembly of any of paragraphs A1-A19, wherein the span has a length, optionally along an/the longitudinal direction.

A20.1. The support assembly of paragraph A20, wherein the longitudinal direction is an elongated direction.

A20.2. The support assembly of any of paragraphs A20-A20.1, wherein the longitudinal direction is horizontal and/or substantially horizontal.

A20.3. The support assembly of any of paragraphs A20-A20.2, wherein the length of the span is at least 20 cm, at least 50 cm, at least 100 cm, or at least 200 cm.

A21. The support assembly of any of paragraphs A1-A20.3, wherein the support beam is configured to withstand a temperature of greater than 100° C., greater than 120° C., greater than 150° C., less than 300° C., less than 250° C., and/or less than 200° C.

A22. The support assembly of any of paragraphs A1-A21, wherein the support beam is configured to withstand contact with a hot workpiece, optionally the workpiece, resting on the support beam, wherein the hot workpiece has a surface temperature of greater than 100° C., greater than 120° C., greater than 150° C., less than 300° C., less than 250° C., and/or less than 200° C.

A23. The support assembly of any of paragraphs A1-A22, wherein the span is not supported with a support leg under the span and/or the workpiece.

A24. The support assembly of any of paragraphs A1-A23, wherein the one or more legs are coupled to the support beam.

A25. The support assembly of any of paragraphs A1-A24, further comprising the workpiece resting on at least the portion of the span of the support beam.

A26. The support assembly of any of paragraphs A1-A25, wherein the workpiece is electrically conductive and/or includes electrically conductive materials.

A27. The support assembly of any of paragraphs A1-A26, wherein the workpiece is magnetic, ferromagnetic, and/or ferrimagnetic.

A28. The support assembly of any of paragraphs A1-A27, wherein the workpiece includes, is composed substantially of, or is composed essentially of, metal, iron, steel, magnetic material, ferromagnetic material, and/or ferrimagnetic material.

A29. The support assembly of any of paragraphs A1-A28, wherein the workpiece has a mass of greater than 10 kg, greater than 20 kg, greater than 40 kg, or greater than 80 kg.

A30. The support assembly of any of paragraphs A1-A29, wherein the workpiece is elongated and has a lineal mass density of greater than 10 kilograms per lineal meter, greater than 20 kilograms per lineal meter, greater than 50 kilograms per lineal meter, or greater than 100 kilograms per lineal meter.

A31. The support assembly of any of paragraphs A1-A30, wherein the workpiece has a length that is at least 20 cm, at least 50 cm, at least 100 cm, or at least 200 cm.

A32. The support assembly of any of paragraphs A1-A31, wherein a/the length of the workpiece is aligned in a/the longitudinal direction of the span.

A33. The support assembly of any of paragraphs A1-A32, wherein the workpiece has a surface temperature of greater than 100° C., greater than 120° C., greater than 150° C., less than 300° C., less than 250° C., and/or less than 200° C.

A34. The support assembly of any of paragraphs A1-A33, wherein the workpiece is a tool, a forming die, or portion thereof, and optionally wherein the forming die includes two or more die mem bers.

A35. The support assembly of any of paragraphs A1-A34, wherein the workpiece is at least one of a billet, a rod, and a sheet.

B1. An induction heating system comprising:

the support assembly of any of paragraphs A1-A35; and

an induction coil that defines an induction heating volume;

wherein the span is at least partially within the induction heating volume and wherein the induction coil is configured to generate an alternating electromagnetic field and/or an alternating magnetic field within the induction heating volume sufficient to heat the workpiece.

B2. The induction heating system of paragraph B1, wherein the induction coil is configured to generate the alternating magnetic field oriented along an alternating magnetic field axis.

B2.1. The induction heating system of paragraph B2, wherein the thicknesses of the metal sheets of the plurality of metal sheets are substantially perpendicular, optionally perpendicular, to the alternating magnetic field axis.

B2.2. The induction heating system of any of paragraphs B2-B2.1, wherein the alternating magnetic field axis is substantially horizontal, optionally horizontal.

B3. The induction heating system of any of paragraphs B1-B2.2, wherein the induction coil is configured to surround the span of the support beam.

B4. The induction heating system of any of paragraphs B1-B3, wherein the induction coil is configured to heat the workpiece resting on the portion of the span by induction heating.

B5. The induction heating system of any of paragraphs B1-B4, wherein the induction coil is configured as a solenoid.

B6. The induction heating system of any of paragraphs B1-B5, wherein the induction coil is substantially cylindrical and/or the induction heating volume is substantially cylindrical.

B7. The induction heating system of any of paragraphs B1-B6, wherein the alternating magnetic field has a frequency of 50 Hz, 60 Hz, 500 Hz, 1 kHz, 10 kHz, 24 kHz, at least 10 Hz, at least 30 Hz, at least 50 Hz, at least 200 Hz, at least 1 kHz, at most 1 MHz, at most 100 kHz, at most 50 kHz, and/or at most 20 kHz, and optionally wherein any of the listed frequencies are about or approximately the listed value.

C1. A method of induction heating a workpiece, the method comprising:

placing a/the workpiece within an induction heating volume of an induction coil, optionally wherein the workpiece is a heating workpiece;

supporting the workpiece within the induction heating volume with the support assembly of any of paragraphs A1-A35; and

inductively heating the workpiece by applying alternating current to the induction coil.

C2. The method of paragraph C1, wherein the applying includes applying an alternating current with a frequency of 50 Hz, 60 Hz, 500 Hz, 1 kHz, 10 kHz, 24 kHz, at least 10 Hz, at least 30 Hz, at least 50 Hz, at least 200 Hz, at least 1 kHz, at most 1 MHz, at most 100 kHz, at most 50 kHz, and/or at most 20 kHz, and optionally wherein any of the listed frequencies are about or approximately the listed value.

C3. The method of any of paragraphs C1-C2, wherein the inductively heating includes heating a surface of the workpiece to a temperature, optionally a predetermined temperature, and optionally wherein the temperature is greater than 100° C., greater than 120° C., greater than 150° C., less than 300° C., less than 250° C., and/or less than 200° C.

C4. The method of any of paragraphs C1-C3, wherein the inductively heating includes heating the workpiece more than the support beam.

C5. The method of any of paragraphs C1-C4, wherein the inductively heating includes heating the workpiece at a rate of greater than 2° C./min, greater than 5° C./min, greater than 10° C/min, and/or less than 50° C./min.

C6. The method of any of paragraphs C1-C5, wherein the inductively heating includes heating the support beam at a rate of less than 2° C./min, less than 1° C./min, less than 0.5° C/min, less than 0.2° C./min, or less than 0.1° C./min.

D1. A method of forming a target workpiece with an induction-heated die, the method comprising:

placing a die within an induction heating volume of an induction coil;

supporting the die within the induction heating volume with the support assembly of any of paragraphs A1-A35, wherein the workpiece associated with the support assembly is the die;

heating the die by induction heating with the induction coil to form a heated die;

placing the heated die in a die press;

placing a target workpiece into the die press; and

forming the target workpiece into a final form with the heated die in the die press.

D2. The method of paragraph D1, wherein the heating includes applying to the induction coil an alternating current with a frequency of 50 Hz, 60 Hz, 500 Hz, 1 kHz, 10 kHz, 24 kHz, at least 10 Hz, at least 30 Hz, at least 50 Hz, at least 200 Hz, at least 1 kHz, at most 1 MHz, at most 100 kHz, at most 50 kHz, and/or at most 20 kHz, and optionally wherein any of the listed frequencies are about or approximately the listed value.

D3. The method of any of paragraphs D1-D2, wherein the heating includes heating a surface of the die to a predetermined temperature, optionally wherein the predetermined temperature is greater than 100° C., greater than 120° C., greater than 150° C., less than 300° C., less than 250° C., and/or less than 200° C.

D4. The method of any of paragraphs D1-D3, wherein the heating includes heating the die more than the support beam.

D5. The method of any of paragraphs D1-D4, wherein the heating includes heating the die at a rate of greater than 2° C./min, greater than 5° C./min, greater than 10° C./min, and/or less than 50° C./min.

D6. The method of any of paragraphs D1-D5, wherein the inductively heating includes heating the support beam at a rate of less than 2° C./min, less than 1° C./min, less than 0.5° C./min, less than 0.2° C./min, or less than 0.1° C./min.

D7. The method of any of paragraphs D1-D6, wherein the heating includes heating two or more die members of the die simultaneously within the induction heating volume.

D8. The method of any of paragraphs D1-D7, wherein the target workpiece is composed essentially of metal, aluminium, and/or aluminium alloy.

D9. The method of any of paragraphs D1-D8, wherein the final form of the target workpiece is an aerospace component, an aircraft stringer, and/or an aircraft frame component.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function. Further, as used herein, the singular forms “a”, “an” and “the” may be intended to include the plural forms as well, unless the context clearly indicates otherwise.

The various disclosed elements of systems and apparatuses, and steps of methods disclosed herein are not required of all systems, apparatuses and methods according to the present disclosure, and the present disclosure includes all novel and non-obvious combinations and subcombinations of the various elements and steps disclosed herein. Moreover, any of the various elements and steps, or any combination of the various elements and/or steps, disclosed herein may define independent inventive subject matter that is separate and apart from the whole of a disclosed system, apparatus, or method. Accordingly, such inventive subject matter is not required to be associated with the specific systems, apparatuses and methods that are expressly disclosed herein, and such inventive subject matter may find utility in systems and/or methods that are not expressly disclosed herein.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, the phrases “at least one of” and “one or more of,” in reference to a list of more than one entity, means any one or more of the entities in the list of entities, and is not limited to at least one of each and every entity specifically listed within the list of entities. For example, “at least one of A and B” (or, equivalently, “at least one of A or B,” or, equivalently, “at least one of A and/or B”) may refer to A alone, B alone, or the combination of A and B.

1. An induction heating-resistant support assembly comprising:
a support beam including a plurality of metal sheets and a plurality of electrically insulating layers interspersed among the metal sheets, electrically isolating the metal sheets from one another, wherein each metal sheet of the plurality of metal sheets has a thickness sized to substantially cancel eddy currents induced in the metal sheet by an alternating magnetic field substantially perpendicular to the thickness, wherein the alternating magnetic field has a frequency of at least 10 Hz and at most 100 kHz; and
one or more legs configured to support the support beam with a workpiece resting on at least a portion of a span of the support beam, wherein the one or more legs are spaced apart from the span, wherein the support beam is configured to support the workpiece resting on the portion of the span, wherein the span has an elongated direction that is horizontal, and wherein the thicknesses of the metal sheets of the plurality of metal sheets are aligned substantially perpendicular to the elongated direction.

2. The support assembly of claim 1, wherein the thickness of each metal sheet of the plurality of metal sheets is less than two times a skin depth of the metal sheet at an alternating magnetic field frequency of 10 kHz.

3. The support assembly of claim 1, wherein the thickness of each metal sheet of the plurality of metal sheets is less than 2 mm.

4. The support assembly of claim 1, wherein each metal sheet of the plurality of metal sheets is non-magnetic.

5. The support assembly of claim 1, wherein adjacent metal sheets of the plurality of metal sheets are spaced apart by one or more electrically insulating layers of the plurality of electrically insulating layers by less than 5 mm and greater than 0.5 mm.

6. The support assembly of claim 1, wherein the support beam is configured to withstand contact with a hot workpiece resting on the support beam, wherein the hot workpiece has a surface temperature of greater than 150° C.

7. The support assembly of claim 1, wherein the span has a length along the elongated direction that is at least 50 cm, wherein the workpiece is elongated, aligned in the elongated direction, and has a lineal mass density of greater than 50 kilograms per lineal meter.

8. The support assembly of claim 1, further comprising a hot workpiece resting on at least the portion of the span of the support beam wherein the hot workpiece has a surface temperature of greater than 150° C.

9. The support assembly of claim 8, wherein the workpiece is a forming die.

10. The support assembly of claim 8, wherein the workpiece is composed substantially of magnetic material.

11. An induction heating system comprising:
a support beam including a plurality of metal sheets and a plurality of electrically insulating layers interspersed among the metal sheets, electrically isolating the metal sheets from one another, wherein each metal sheet of the plurality of metal sheets has a thickness;
one or more legs configured to support the support beam with a workpiece resting on at least a portion of a span of the support beam, wherein the one or more legs are spaced apart from the span, and wherein the support beam is configured to support the workpiece resting on the portion of the span; and
an induction coil that defines an induction heating volume;
wherein the span is at least partially within the induction heating volume, wherein the induction coil is configured to generate an alternating magnetic field within the induction heating volume sufficient to heat the workpiece, wherein the alternating magnetic field is substantially perpendicular to the thicknesses of the metal sheets of the plurality of metal sheets, wherein the alternating magnetic field has a frequency of at least 10 Hz and at most 100 kHz, and wherein the thickness of each metal sheet of the plurality of metal sheets is sized to substantially cancel eddy currents induced in the metal sheet by the alternating magnetic field.

12. The induction heating system of claim 11, wherein the thickness of each metal sheet of the plurality of metal sheets is less than two times a skin depth of the metal sheet at an alternating magnetic field frequency of 10 kHz.

13. The induction heating system of claim 11, wherein the thickness of each metal sheet of the plurality of metal sheets is less than 5 mm.

14. The induction heating system of claim 11, wherein adjacent metal sheets of the plurality of metal sheets are spaced apart by one or more electrically insulating layers of the plurality of electrically insulating layers by less than 20 mm and greater than 0.1 mm.

15. The induction heating system of claim 11, wherein the span has a length of at least 50 cm and wherein the workpiece has a mass of greater than 20 kg.

16. The induction heating system of claim 11, wherein the support beam is configured to withstand contact with a hot workpiece resting on the support beam, wherein the hot workpiece has a surface temperature of greater than 120° C.

17. A method of induction heating, the method comprising:
placing a heating workpiece within an induction heating volume of an induction coil;
supporting the heating workpiece within the induction heating volume with a support assembly, wherein the support assembly includes:
a support beam including a plurality of metal sheets and a plurality of electrically insulating layers interspersed among the metal sheets, electrically isolating the metal sheets from one another, wherein each metal sheet of the plurality of metal sheets has a thickness sized to substantially cancel eddy currents induced in the metal sheet by an alternating magnetic field substantially perpendicular to the thickness, and
one or more legs configured to support the support beam with the heating workpiece resting on at least a portion of a span of the support beam, wherein the one or more legs are spaced apart from the span, and wherein the support beam is configured to support the heating workpiece resting on the portion of the span; and
inductively heating the heating workpiece by applying to the induction coil an alternating current with a frequency of at least 10 Hz and at most 100 kHz.

18. The method of claim 17, wherein the inductively heating includes heating a surface of the heating workpiece to a temperature of greater than 120° C.

19. The method of claim 17, wherein the inductively heating includes heating the heating workpiece at a rate of greater than 5° C./min and heating the support beam at a rate of less than 1° C./min.

20. The method of claim 17, wherein the heating workpiece is a die, the inductively heating includes heating the die to form a heated die, and the method further comprises:
placing the heated die in a die press;
placing a target workpiece into the die press; and
forming the target workpiece into a final form with the heated die in the die press.
